(19) United States
(12) Patent Application Publication
(10) Pub. No.: US 2005/0154998 A1
(43) Pub. Date: Jul. 14, 2005

(54) PERIPHERAL DEVICE DRIVER WITH AUTOMATIC INQUIRY OF USER PREFERENCES

(75) Inventor: Rono James MATHIESON, Camas, WA (US)

Correspondence Address: DAVID C RIPMA, PATENT COUNSEL;SHARP LABORATORIES OF AMERICA, 5750 NW PACIFIC RIM BLVD, CAMAS, WA, 98607, US

(73) Assignee: SHARP LABORATORIES OF AMERICA, INC., Camas, WA (US)

(21) Appl. No.: 10/907,175

(22) Filed: Mar. 23, 2005

Related U.S. Application Data
(63) Continuation-in-part of application No. 09/587,629, filed on Jun. 5, 2000.

(51) Int. Cl. G06F 3/00; G06F 15/00

(52) U.S. Cl. 715/809; 715/810; 358/1.15; 358/1.14

(57) ABSTRACT

In response to an indication received from an application that a user has selected an operation provided by a peripheral device, a driver for the peripheral device automatically opens a dialog box, or user interface (UI) thereby allowing the user to take advantage of the capabilities of a peripheral device.

### CROSS-REFERENCE TO RELATED PATENT APPLICATION

The present patent application is a continuation-in-part patent application of co-assigned and copending U.S. patent application Ser. No. 09/587,629, entitled “Printer Driver With Automatic Inquiry of User Preferences,” invented by Rono James Mathieson, filed Jun. 5, 2000, and which is incorporated by reference herein.

### FIELD OF THE INVENTION

The present invention relates to a peripheral user interface. More specifically, the present invention relates to a user interface that negates the need for a user to launch a driver in order to make control changes in a peripheral device.

### BACKGROUND OF THE INVENTION

It is often difficult for a user to setup peripheral devices, and particularly peripheral devices in an office-network environment to perform jobs when the user is limited to using a conventional peripheral driver set-up technique because a user is required to actively find and open the driver for controlling advanced functions of the peripheral device. This difficulty exists for peripheral devices such as printers, facsimile machines, scanners and multi-function peripheral (MFP) devices. For example, in order to print a job, a user typically can select an icon appearing on a task bar of an application, such as a Windows™ application, that causes a peripheral printer device to proceed using preset, default parameters without opening a driver user interface (UI) for the peripheral printer. Alternatively, a user could select an option from within a “File” menu of an application that causes the application to presents a dialog box that typically includes a “Properties” button. Selecting the “Properties” button opens a driver UI for the printer. At this point, the user could specify advanced properties for the printer to handle the print job. Nevertheless, few users take advantage of the capabilities of powerful modern office peripheral devices or may do so only with considerable effort because of the difficulty of the conventional approach.

Additionally, considering the increased capabilities of modern office peripherals, a user may often want and need to change settings of a peripheral device. For example, a user may often want to print double-sided documents and, consequently, desire to be able easily to enable and disable the duplex function for the printer. Similarly, the user may need to enable and disable a staple function for the printer. Conventional peripheral devices force a user to perform an inefficient and time-consuming process of modifying the driver, as described above. Accordingly, the complexity of modifying a driver for a peripheral device causes the process to be error prone. Perhaps the most irritating aspect of modifying a printer driver is that the modification generally “sticks,” i.e., becomes a default setting, so that when a user has printed a document as, for example, duplex, landscape and stapled, the next document printed will also print as duplex, landscape and stapled unless the user remembers to reset the driver for the printer to desired default settings, such as simplex, portrait, no staple.

FIGS. 1-3 depict user interfaces illustrating the conventional approach for printing a job. In FIG. 1, an application window is depicted at 10. The first step of a print process requires a user to select “File” 12 and then select “Print” 14. It should be noted that, in many Windows™ applications, when a user selects “Print” icon 16, the job is immediately sent to a printer with no opportunity for the user to select any options. FIG. 2 depicts an application print UI, or “Print Menu” 18 that opens in response to selection of Print 14 in FIG. 1. Print menu 18 includes a “Properties” button 20. Selecting “Properties” button 20 produces a driver UI for the printer, or “Properties Menu” 22 shown in FIG. 3, which provides access to five additional menus (Finishing, Effects, Paper, Destination, and Basics), each containing a variety of print options, such as “Duplex” 24, “Print Quality” 26, “Collate” 28, etc. A user must navigate through five menus, setting specific desired parameters from each of the menus. Once the “Properties” have been set, a user selects “OK” on each of the five “Properties” menus, and then selects “OK” on the “Print” menu.

U.S. Pat. No. 4,991,114 to Kawamura et al., for Printer comprising display means for displaying operation state thereof, granted Feb. 5, 1991, describes a user interface that only provides for status display.

U.S. Pat. No. 5,555,077 to Schooley, for Printer having an active user interface feature, granted Sep. 10, 1996, describes a user interface that is specific to a device rather than relating to the printer driver.

U.S. Pat. No. 5,706,411 to McCormick et al., for Printer status user interface and methods relating thereto, granted Jan. 6, 1998, only provides for status display and does not provide a user interface for setting of user preferences.

### SUMMARY OF THE INVENTION

The present invention provides computer-executable process steps that are stored on a computer-readable medium and are for providing a peripheral-device user interface. In particular, the computer-executable process steps include receiving an indication from an application that a user has selected an operation provided by the peripheral device, activating, in response to the received indication, a device driver for the peripheral device, the device driver for the peripheral device being independent from the application, and generating a peripheral-device user interface in response to activation of the device driver for the peripheral device. The peripheral-device user interface can includes a bypass function for disabling the device driver from generating the peripheral-device user interface. In one exemplary embodiment of the present invention, the selected operation provided by the peripheral device is a scanning operation. In another exemplary embodiment of the present invention, the selected operation provided by the peripheral device is a printing operation. In yet another exemplary embodiment, the selected operation provided by the peripheral device is a facsimile transmission operation. In still another exemplary embodiment of the present invention, the computer-readable medium is a magnetic computer-readable medium, while in an even further exemplary embodiment, the computer-readable medium is an optical computer-readable medium.

### BRIEF DESCRIPTION OF THE DRAWINGS

The present invention is illustrated by way of example and not by limitation in the accompanying figures in which like reference numerals indicate similar elements and in which:

FIG. 1 is a conventional pull-down File menu for MSWord 97®;

FIG. 2 is a conventional pull-down Print menu for MSWord 97®;

FIG. 3 is a conventional pull-down Printer Properties menu for MSWord 97®;

FIG. 4 is an exemplary print-selection user interface according to the invention;

FIG. 5 is an exemplary print-options user interface according to the invention;

FIG. 6 depicts a flow diagram for automatically opening a dialog box or UI on a display after a user invokes an operation involving a peripheral device according to the present invention; and

FIG. 7 depicts a storage device having a memory space formed within a computer-readable medium in which computer-executable process steps for automatically opening a dialog box or UI on a display after a user invokes an operation involving a peripheral device according to the present invention can be stored.

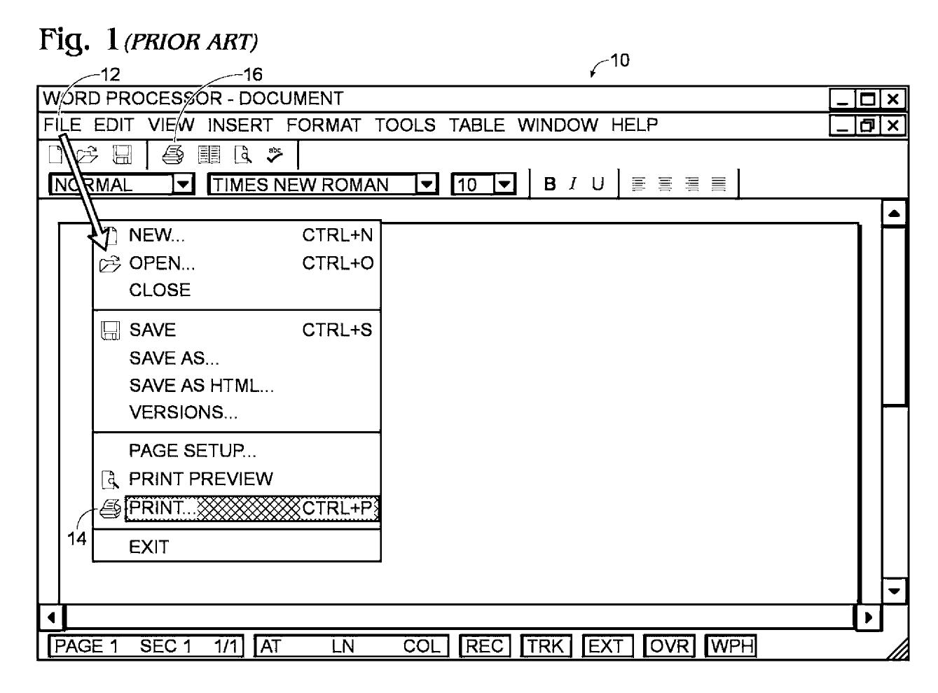

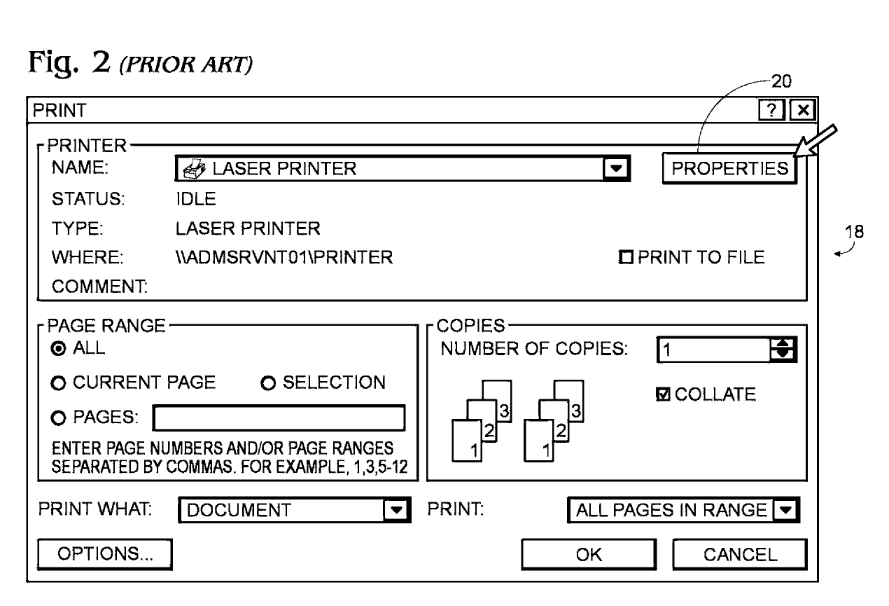

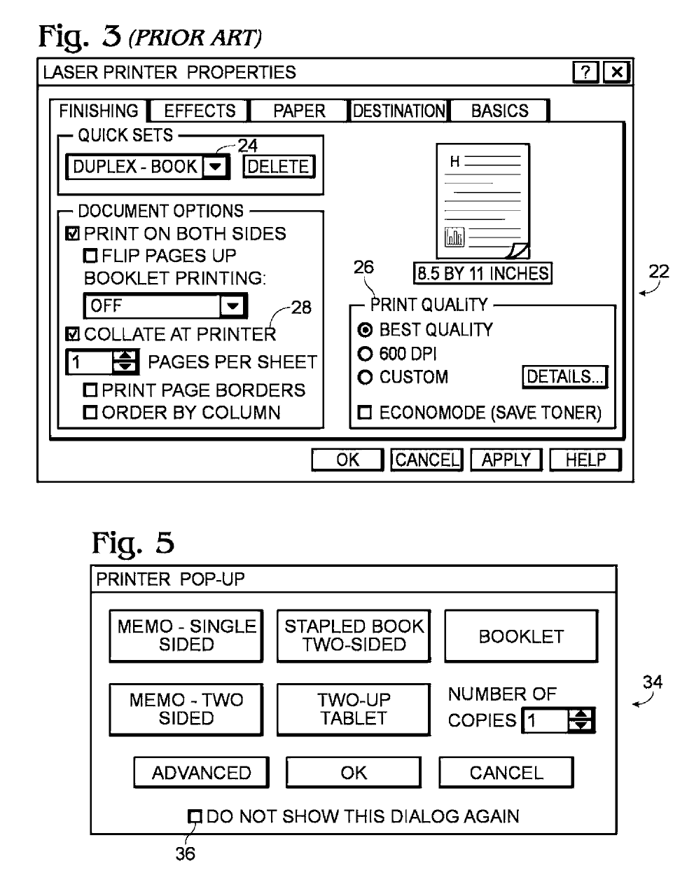

### DETAILED DESCRIPTION OF THE PRESENT INVENTION

The present invention automatically opens, or activates, a dialog box, or user interface (UI), on a display after a user invokes an operation involving a peripheral device. The dialog box presents options to a user allowing a user to take advantage of the capabilities of a peripheral device. It should be understood that the present invention could be used with printers, facsimiles, scanners or multi-function peripheral (MFP) devices, even though the examples disclosed herein focus on use of the present invention with a peripheral printing device. For example, when a user selects the print icon appearing in a tool bar of an application, a dialog box is opened that offers a user choices such as the number of copies printed, two-sided book style, two-sided presentation style, staple and other advanced features. A user then selects the appropriate buttons for desired options.

The present invention differs from the conventional drivers in that conventional drivers that are supplied by a vendor of a peripheral device, i.e., a driver for a peripheral printer, do not automatically open a dialog box, or a UI, on a display when a user selects a “Print” icon on the command bar or when the user selects the command sequence “File, Print, OK.” Selecting the preceding conventional sequence merely prints a job in accordance with the default or last-selected parameters, which may not be appropriate for the current print job, i.e., duplex on/off, staple on/off. In contrast, the present invention changes, for example, a printing process when a peripheral printing device is selected by providing a software component that is supplied by a vendor of a peripheral device that automatically opens, or activates, a dialog box on a display. The dialog box offers to a user a set of options for the peripheral printer device. The software component may take the form of a modified driver for a peripheral device, but may also be a modified Windows™ component, supplied by the vendor of the peripheral device, that functions similarly to a driver for the peripheral device.

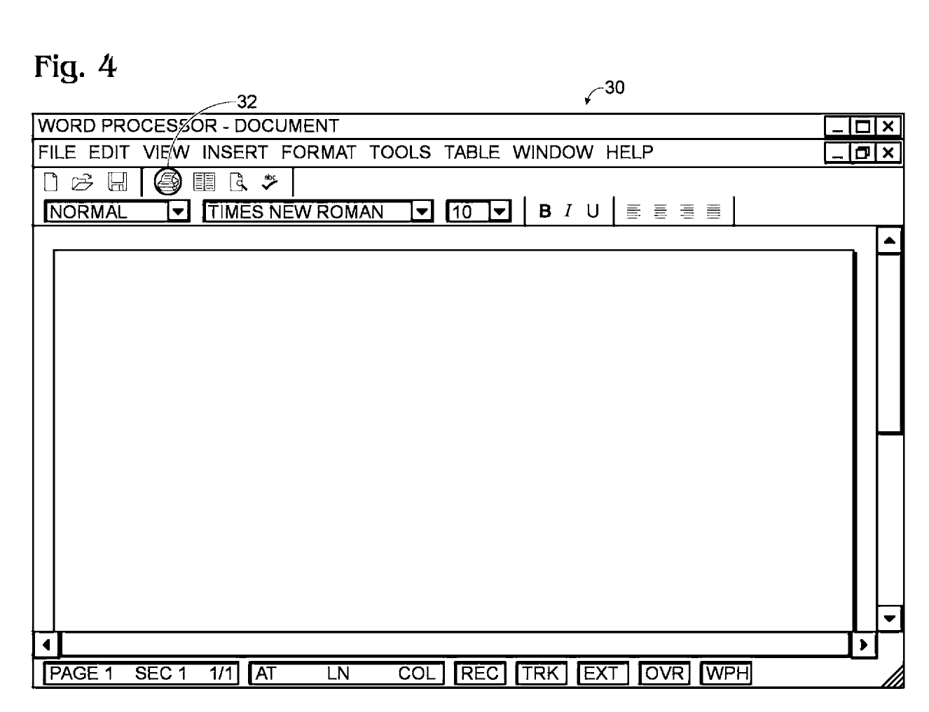

Referring now to FIGS. 4 and 5, an application window is shown generally at 30. Window 30 includes a print icon 32. A dialog box, or peripheral option display, 34 appears on a display immediately after icon 32 is selected and the application passes control of the printing operation to the driver. Dialog box 34 allows selection of user preferences to be made following the selection of a print command function. As previously noted, conventional systems do not offer options to a user and only use default settings when the user selects the print icon on the task bar, or use the “File, Print, OK” sequence. The present invention provides a fundamentally different printing process, especially in a Windows™ environment.

Dialog box 34 is an exemplary UI that is generated by the driver for the peripheral printer, or by a Windows™ component replacement. A conventional driver for a printer normally executes a printing process using the current default settings and does not present a dialog box to a user enumerating available choices. Because dialog box 34 is part of the driver for the printer, dialog box 34 may pass instructions to the peripheral device in the same way that would have been done had a user selected a conventional “File, Print, Properties” sequence, and then selected desired parameters.

Dialog box 34 may be provided by an OEM, or may be customizable from within an existing driver for a peripheral in the form of an add-on software component. For example, an existing driver for a printer may offer a protocol for a user to set-up a predefined print format, i.e., duplex presentation in which two-sided, landscape, tablet and staple are selected. Such a predefined print format may then be displayed as function names on buttons of dialog box 34. This capability may be extended to allow an MIS department to determine the set of buttons that appear for each particular user at the time when the MIS department establishes a customer account for the user. In this way, advanced functionality may be delivered to a novice user. For example, a user may set up default, predefined print formats and install the default formats at the same time that the peripheral is installed on a computer used by the user. A user may also set up default, predefined print formats on a server, such as a Windows® NT server. When the device is installed on a computer of the user from the server, the default, predefined print formats are also installed and, therefore, made available to the user.

The dialog box would also typically contain an advanced-settings button that would open the full UI for the driver. The dialog box typically will have a field that could be checked, such as a “Do not display this dialog again” option 36, that would allow the user to de-select, or turn off dialog box 34 when a user does not wish to use dialog box 34. When the dialog box is de-selected, selecting “Print” icon 32 results in the job being sent to the last selected printer using the last selected option set. It should be appreciated that, as used herein, and when dialog box 34 is not de-selected, “displaying peripheral options” means that the options, or menu, is displayed immediately and there is no need for a user to navigate through a long sequence of menu boxes to reach the “properties” box, and make appropriate settings.

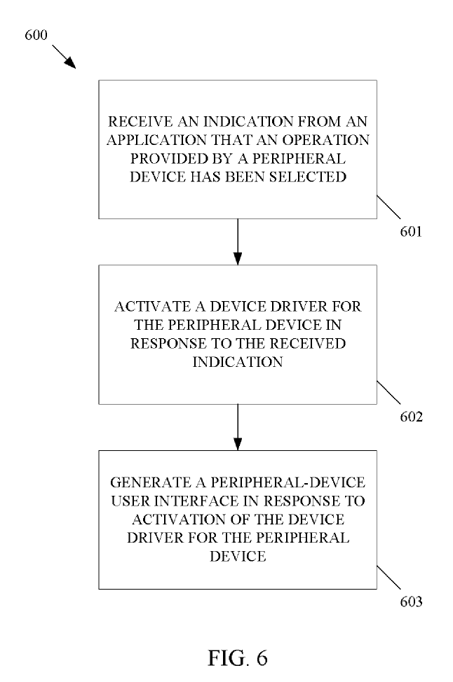

FIG. 6 depicts a flow diagram 600 for automatically opening a dialog box or UI on a display after a user invokes an operation involving a peripheral device according to the present invention. At step 601, an indication is received from an application that a user has selected an operation provided by the peripheral device. At step 602, a device driver for the peripheral device is activated in response to the received indication. According to the present invention, the device driver for the peripheral device is independent from the application. At step 603, a peripheral-device user interface is generated, or opened, in response to activation of the device driver for the peripheral device.

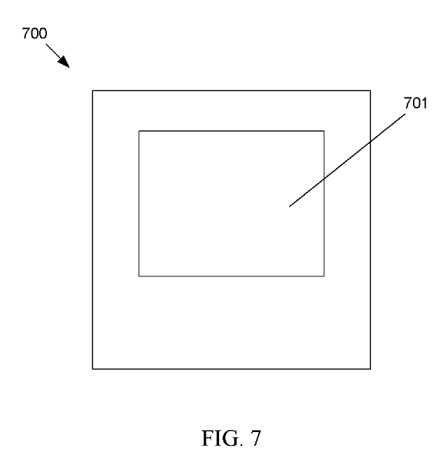

FIG. 7 depicts a storage device 700, such as, but not limited to, a floppy disk or a CD, having a memory space 701 formed within a computer-readable medium in which computer-executable process steps can be stored. In particular, storage device 700 stores computer-executable process steps for use on a computer system for providing a peripheral-device user interface for automatically opening a dialog box or UI on a display after a user invokes an operation involving a peripheral device, such as described in connection with FIG. 6.

It will be appreciated that further variations and modifications thereof may be made within the scope of the invention as defined in the appended claims.

1. Computer-executable process steps stored on a computer-readable medium, the process steps for use on a computer system for providing a peripheral-device user interface, the process steps comprising:
receiving an indication from an application that a user has selected an operation provided by the peripheral device;
activating, in response to the received indication, a device driver for the peripheral device, the device driver for the peripheral device being independent from the application; and
generating a peripheral-device user interface in response to activation of the device driver for the peripheral device.

2. The computer-executable process steps according to claim 1, wherein the selected operation provided by the peripheral device is a scanning operation.

3. The computer-executable process steps according to claim 1 wherein the selected operation provided by the peripheral device is a printing operation.

4. The computer-executable process steps according to claim 1, wherein the selected operation provided by the peripheral device is a facsimile transmission operation.

5. The computer-executable process steps according to claim 1, wherein peripheral-device user interface includes a bypass function for disabling the device driver from generating the peripheral-device user interface.

6. The computer-executable process steps according to claim 1, wherein the computer-readable medium is a magnetic computer-readable medium.

7. The computer-executable process steps according to claim 1, wherein the computer-readable medium is an optical computer-readable medium.
